(19) United States
(12) Patent Application Publication
(10) Pub. No.: US 2016/0239589 A1
(43) Pub. Date: Aug. 18, 2016

(54) Automatic calibration of thermal models

(71) Applicant: Mentor Graphics Corporation, Wilsonville, OR (US)

(72) Inventors: Byron Blackmore, Nova Scotia (CA); Robin Bornoff, Herefordshire (GB)

(73) Assignee: Mentor Graphics Corporation

(21) Appl. No.: 14/757,891

(22) Filed: Dec. 23, 2015

Related U.S. Application Data
(60) Provisional application No. 62/096,444, filed on Dec. 23, 2014.

(51) Int. Cl. G06F 17/50

(52) U.S. Cl. CPC G06F 17/5009

(57) ABSTRACT

Techniques for calibrating thermal models are disclosed. A plurality of thermal model parameter value sets for a structure are first determined. Using the plurality of thermal model parameter value sets, thermal transient response simulations are performed to obtain a plurality of simulation results. Each of the plurality of simulation results is derived based on one of the plurality of thermal model parameter value sets. Based on the plurality of simulation results and an experimental result obtained from a thermal transient response measurement of the structure, calibrated thermal model parameter values for the structure are computed.

### RELATED APPLICATIONS

This application claims the benefit of U.S. Provisional Patent Application No. 62/096,444, filed on Dec. 23, 2014, and naming Byron Blackmore et al. as inventors, which application is incorporated entirely herein by reference.

### FIELD OF THE DISCLOSED TECHNOLOGY

The present disclosed technology is directed to the thermal analysis. Various aspects of the disclosed technology may be particularly useful for calibrating thermal models for circuit packages.

### BACKGROUND OF THE DISCLOSED TECHNOLOGY

High operating temperatures can severely affect the performance, power consumption and reliability of a circuit system. With the continued scaling of integrated circuit technologies, high power density and the resulting difficulties in managing temperatures have become a major challenge for designers at all design levels. Computer modeling tools have been employed to predict and simulate the thermal behavior of both physical and virtual structures. The predictive accuracy of such a tool depends on a number of factors. One important factor is the accuracy of thermal model parameters used by the tool.

To determine proper thermal model parameter values, conventional approaches are guess and check relying on practitioner experience. A set of thermal model parameter values is assumed, the simulation is performed, and results are compared to experimental data measured with an instrument. Practitioners with experience can make educated guesses based on the profile and values of the measured response or structure functions (mathematical manipulations of the measured response), reducing the number of guess and check iterations required to achieve the desired accuracy. The process for determining proper thermal model parameter values is usually referred to as calibration of thermal models.

The above conventional model calibration approach is essentially a manual iteration process. The number of iterations needed to find a reasonable match with the experimental results is uncertain and depends upon the practitioner's experience. For complex structures, significant expertise may be required. It is thus desirable to develop an automatic approach that can lessen the level of expertise.

### BRIEF SUMMARY OF THE DISCLOSED TECHNOLOGY

Aspects of the disclosed technology relate to techniques for calibrating thermal models. In one aspect, there is a method, executed by at least one processor of a computer, comprising: determining a plurality of thermal model parameter value sets for a structure, each of the plurality of thermal model parameter value sets consisting of preliminary values for a set of thermal model parameters, the structure including at least one microelectronic device; performing thermal transient response simulations using the plurality of thermal model parameter value sets to obtain a plurality of simulation results, each of the plurality of simulation results being derived based on one of the plurality of thermal model parameter value sets; and computing calibrated thermal model parameter values for the structure based on the plurality of simulation results and an experimental result obtained from a thermal transient response measurement of the structure.

The determining may be based on minimum values and maximum values for the set of thermal model parameters. The set of thermal model parameters may be a subset of thermal model parameters needed for the thermal transient response simulation. The subset of thermal model parameters may comprise thermal model parameters that are difficult to measure directly.

Each of the plurality of simulation results may comprise a structure function and the experimental result may comprise a structure function.

The computing may comprise determining a deviation value for each of the plurality of thermal model parameter value sets. The deviation value may be a sum of squared errors obtained by comparing a structure function obtained from the each of the thermal transient response simulations to a structure function obtained from the thermal transient response measurement. The computing may further comprise: constructing a response surface function using the deviation values; and determining calibrated thermal model parameter values using response surface methodology.

In another aspect, there are one or more non-transitory computer-readable media storing computer-executable instructions for causing one or more processors to perform the above method.

In still another aspect, there is a system comprising one or more processors, the one or more processors programmed to perform the above method.

Certain inventive aspects are set out in the accompanying independent and dependent claims. Features from the dependent claims may be combined with features of the independent claims and with features of other dependent claims as appropriate and not merely as explicitly set out in the claims.

Certain objects and advantages of various inventive aspects have been described herein above. Of course, it is to be understood that not necessarily all such objects or advantages may be achieved in accordance with any particular embodiment of the disclose techniques. Thus, for example, those skilled in the art will recognize that the disclose techniques may be embodied or carried out in a manner that achieves or optimizes one advantage or group of advantages as taught herein without necessarily achieving other objects or advantages as may be taught or suggested herein.

### BRIEF DESCRIPTION OF THE DRAWINGS

FIG. 1 illustrates an example of a programmable computer that may be used to implement a model calibration tool or method according to various embodiments of the disclosed technology.

FIG. 2 illustrates a model calibration tool according to various embodiments of the disclosed technology.

FIG. 3 illustrate a flowchart showing methods of calibrating thermal models according to various embodiments of the disclosed technology.

FIG. 4 illustrate an example of a normalized transient thermal impedance graph.

FIG. 5A illustrate an example of a structure function in the integral form.

FIG. 5B illustrate a cross section of the physical structure of a package, of which the structure function is shown in FIG. 5A.

### DETAILED DESCRIPTION OF THE DISCLOSED TECHNOLOGY

### General Considerations

Various aspects of the disclosed technology relate to calibrating thermal models. In the following description, numerous details are set forth for the purpose of explanation. However, one of' ordinary skill in the art will realize that the disclosed technology may be practiced without the use of these specific details. In other instances, well-known features have not been described in details to avoid obscuring the present disclosed technology.

Some of the techniques described herein can be implemented in software instructions stored on a computer-readable medium, software instructions executed on a computer, or some combination of both. Some of the disclosed techniques, for example, can be implemented as part of an electronic design automation (EDA) tool. Such methods can be executed on a single computer or on networked computers.

Although the operations of the disclosed methods are described in a particular sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular methods can be used in conjunction with other methods. Additionally, the detailed description sometimes uses terms like “determine”, “perform” and “compute” to describe the disclosed methods. Such terms are high-level abstractions of the actual operations that are performed. The actual operations that correspond to these terms will vary depending on the particular implementation and are readily discernible by one of ordinary skill in the art.

### Illustrative Operating Environment

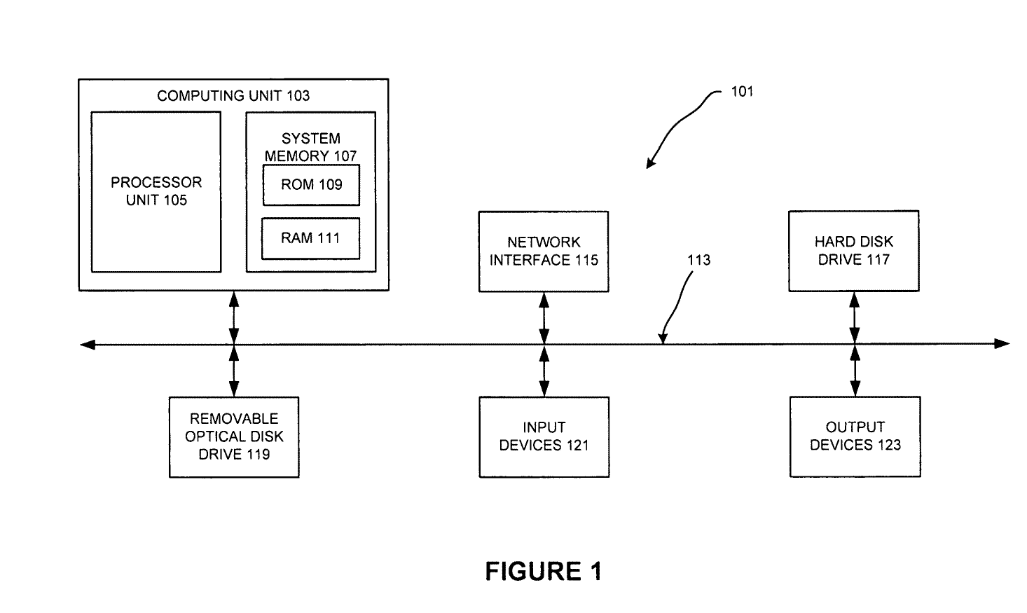

Various examples of the disclosed technology may be implemented through the execution of software instructions by a computing device, such as a programmable computer. Accordingly, FIG. 1 shows an illustrative example of a computing device 101. As seen in this figure, the computing device 101 includes a computing unit 103 with a processing unit 105 and a system memory 107. The processing unit 105 may be any type of programmable electronic device for executing software instructions, but will conventionally be a microprocessor. The system memory 107 may include both a read-only memory (ROM) 109 and a random access memory (RAM) 111. As will be appreciated by those of ordinary skill in the art, both the read-only memory (ROM) 109 and the random access memory (RAM) 111 may store software instructions for execution by the processing unit 105.

The processing unit 105 and the system memory 107 are connected, either directly or indirectly, through a bus 113 or alternate communication structure, to one or more peripheral devices. For example, the processing unit 105 or the system memory 107 may be directly or indirectly connected to one or more additional memory storage devices, such as a “hard” magnetic disk drive 115, a removable magnetic disk drive 117, an optical disk drive 119, or a flash memory card 121. The processing unit 105 and the system memory 107 also may be directly or indirectly connected to one or more input devices 123 and one or more output devices 125. The input devices 123 may include, for example, a keyboard, a pointing device (such as a mouse, touchpad, stylus, trackball, or joystick), a scanner, a camera, and a microphone. The output devices 125 may include, for example, a monitor display, a printer and speakers. With various examples of the computer 101, one or more of the peripheral devices 115-125 may be internally housed with the computing unit 103. Alternately, one or more of the peripheral devices 115-125 may be external to the housing for the computing unit 103 and connected to the bus 113 through, for example, a Universal Serial Bus (USB) connection.

With some implementations, the computing unit 103 may be directly or indirectly connected to one or more network interfaces 127 for communicating with other devices making up a network. The network interface 127 translates data and control signals from the computing unit 103 into network messages according to one or more communication protocols, such as the transmission control protocol (TCP) and the Internet protocol (IP). Also, the interface 127 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computer 101 is illustrated as an example only, and it not intended to be limiting. Various embodiments of the disclosed technology may be implemented using one or more computing devices that include the components of the computer 101 illustrated in FIG. 1, which include only a subset of the components illustrated in FIG. 1, or which include an alternate combination of components, including components that are not shown in FIG. 1. For example, various embodiments of the disclosed technology may be implemented using a multi-processor computer, a plurality of single and/or multiprocessor computers arranged into a network, or some combination of both.

### Model Calibration Tool

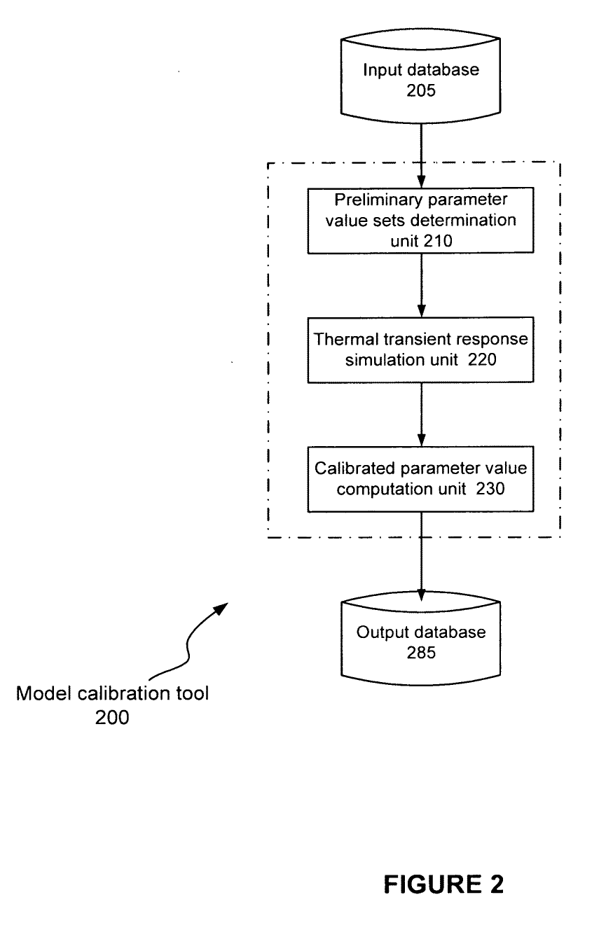

FIG. 2 illustrates an example of a model calibration tool according to various embodiments of the disclosed technology. As seen in this figure, the model calibration tool 200 includes a preliminary parameter value sets determination unit 210, a thermal transient response simulation unit 220, and a calibrated parameter value computation unit 230. Some implementations of the model calibration tool 200 may cooperate with (or incorporate) one or both of an input database 205 and an output database 285.

As will be discussed in more detail below, the preliminary parameter value sets determination unit 210 determines a plurality of thermal model parameter value sets for a structure. The structure includes at least one microelectronic device. Each of the plurality of thermal model parameter value sets consists of preliminary values for a set of thermal model parameters. Using the plurality of thermal model parameter value sets, the thermal transient response simulation unit 220 performs thermal transient response simulations to obtain a plurality of simulation results. Based on the plurality of simulation results and an experimental result obtained from a thermal transient response measurement of the structure, the calibrated parameter value computation unit 230 computes calibrated thermal model parameter values for the structure.

As previously noted, various examples of the disclosed technology may be implemented by a computing system, such as the computing system illustrated in FIG. 1. Accordingly, one or more of the preliminary parameter value sets determination unit 210, the thermal transient response simulation unit 220, and the calibrated parameter value computation unit 230 may be implemented by executing programming instructions on one or more processors in a computing system such as the computing system illustrated in FIG. 1. Correspondingly, some other embodiments of the disclosed technology may be implemented by software instructions, stored on a non-transitory computer-readable medium, for instructing one or more programmable computers/computer systems to perform the functions of one or more of the preliminary parameter value sets determination unit 210, the thermal transient response simulation unit 220, and the calibrated parameter value computation unit 230. As used herein, the term “non-transitory computer-readable medium” refers to computer-readable medium that are capable of storing data for future retrieval, and not propagating electro-magnetic waves. The non-transitory computer-readable medium may be, for example, a magnetic storage device, an optical storage device, a “punched” surface type device, or a solid state storage device.

It also should be appreciated that, while of the preliminary parameter value sets determination unit 210, the thermal transient response simulation unit 220, and the calibrated parameter value computation unit 230 are shown as separate units in FIG. 2, a single computer (or a single processor within a master computer) may be used to implement all of these units at different times, or components of these units at different times.

With various examples of the disclosed technology, the input database 205 and the output database 285 may be implemented using any suitable computer readable storage device. That is, either of the input database 205 and the output database 285 may be implemented using any combination of computer readable storage devices including, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable storage devices may also include magnetic cassettes, magnetic tapes, magnetic disks or other magnetic storage devices, punched media, holographic storage devices, or any other non-transitory storage medium that can be used to store desired information. While the input database 205 and the output database 285 are shown as separate units in FIG. 2, a single data storage medium may be used to implement some or all of these databases.

### Thermal Model Automatic Calibration

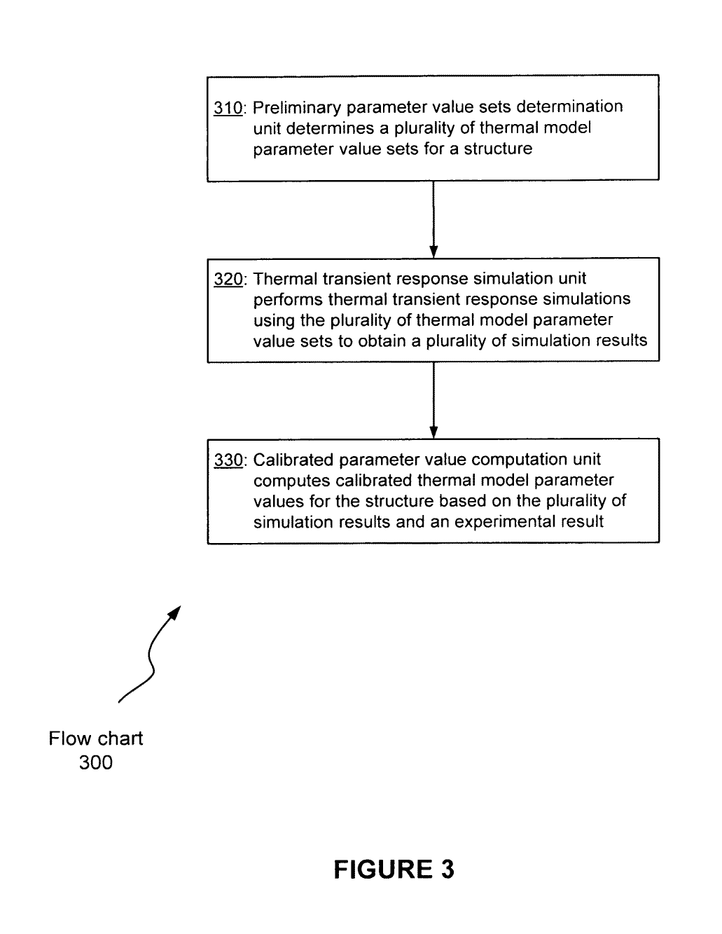

FIG. 3 illustrates a flowchart 300 showing a process of thermal model automatic calibration that may be implemented according to various examples of the disclosed technology. For ease of understanding, methods of thermal model automatic calibration that may be employed according to various embodiments of the disclosed technology will be described with reference to the model calibration tool 200 illustrated in FIG. 2. It should be appreciated, however, that alternate implementations of a model calibration tool may be used to perform the methods of thermal model automatic calibration in the flow chart 300 according to various embodiments of the disclosed technology. In addition, it should be appreciated that implementations of the model calibration tool 200 may be employed to implement methods of thermal model automatic calibration according to different embodiments of the disclosed technology other than the ones illustrated by the flow chart 300.

Initially, in operation 310, the preliminary parameter value sets determination unit 210 determines a plurality of thermal model parameter value sets for a structure. The structure includes at least one microelectronic device. One example of the structure is an integrated circuit package. The integrated circuit package includes an integrated circuit fabricated on a die. The package also includes parts for encapsulation or seal and heat dissipation. Another example of the structure is an electronic package that mounts and interconnects of integrated circuits and other components onto printed-circuits boards.

Thermal properties of a structure such as the peak junction temperature and temperature gradient distributions throughout a transient event may be predicted using a software simulation tool. An example of such a tool is the FloTHERM® family of software products available from Mentor Graphics Corporation of Wilsonville, Oreg. The software simulation tool needs data inputs for a number of thermal model parameters. The closer these thermal model parameter values represent the structure, the more accurate the prediction results are. Values for some of the thermal model parameters may be determined, for example by experiment, accurately, and thus do not need to be calibrated. Values for some other thermal model parameters should be calibrated because they either cannot be determined by experiment or are not known with certainty. Die active surface area, effective thermal interface material thickness and/or thermal conductivity are typically in this category.

For the thermal model parameters to be calibrated, value ranges are typically known or can be estimated. The preliminary parameter value sets determination unit 210 may select a value within the minimum and maximum values for each of the thermal model parameters to be calibrated to form a thermal model parameter value set as input for the software simulation tool. For calibration, a plurality of thermal model parameter value sets are determined. One simple approach of the determination is based on dividing each of the value ranges for the thermal model parameters uniformly and generating different combinations of the thermal model parameter values. The number of the thermal model parameter value sets and the spacing between neighboring a thermal model parameter value may affect the result of the thermal model calibration.

Next, in operation 320, the thermal transient response simulation unit 220 performs thermal transient response simulations using the plurality of thermal model parameter value sets to obtain a plurality of simulation results. The thermal transient response simulation unit 220 may be implemented with conventional thermal modeling software, such as the FloTHERM® family of software products available from Mentor Graphics Corporation of Wilsonville, Oreg. To facilitate comparison with experimental results, the simulation results may include those for locations or components of the structure that have measurement results. The heat source and input/output pins of an integrated circuit are two examples.

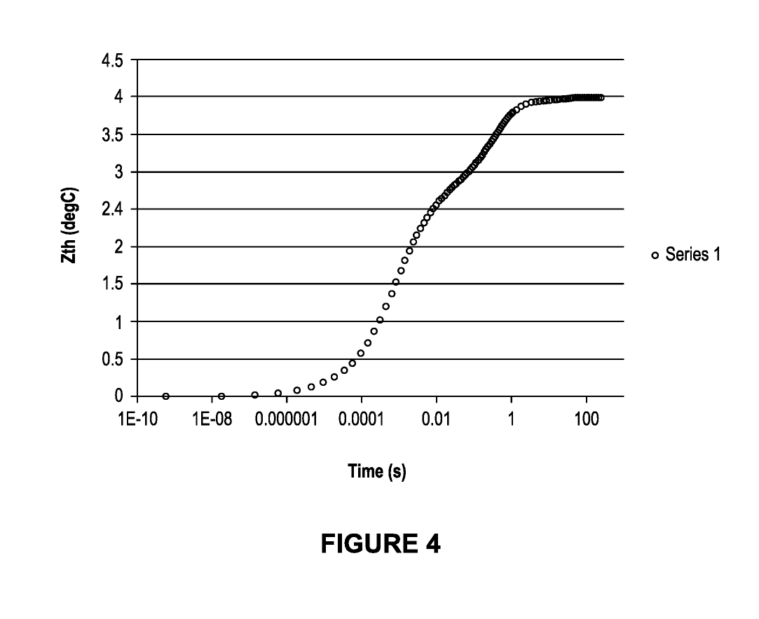

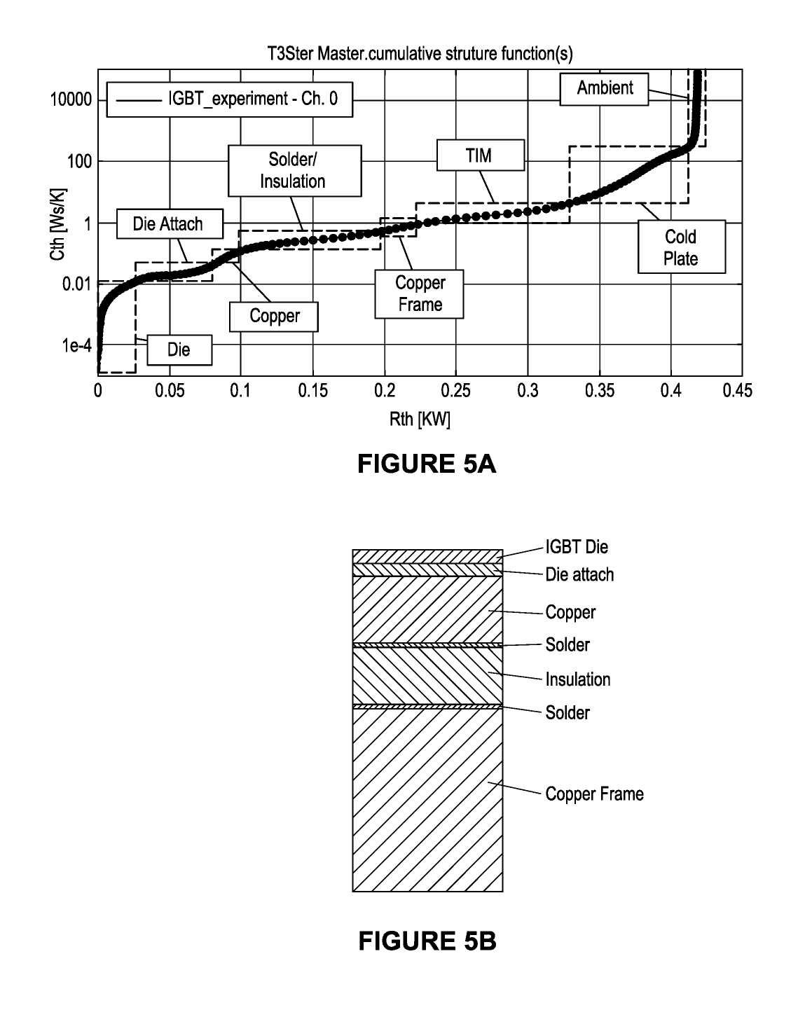

Simulation results may be represented by normalized transient thermal impedance curves (Zth) curves. The Zth curve can also be derived from experiment using a thermal transient measurement technique. An example of a Zth curve is shown in FIG. 4. As can be seen in FIG. 4, the Zth curve is in time-domain and does not show structural information explicitly. Fine structure of heat flow path can be viewed directly from a structure function, which can be extracted from the Zth curve. The structure function transforms a thermal transient response profile into a thermal resistance vs. thermal capacitance profile. Physical characteristics of components of a structure such as layers, base, package, heat-sink and even cooling devices of a circuit package can be identified. FIG. 5A illustrates an example of a structure function of a circuit package. In the figure, different segments of curve are labeled with corresponding components of the circuit package and environment. Here, TIM stands for thermal interface material.

FIG. 5B shows a cross section of the physical structure of the package. The structure function may be represented in either an integral form (the one shown in FIG. 5A) or a differential form. More information about the structure function can be found in R. Bornoff et al., “A Detailed IC Package Numerical Model Calibration Methodology”, 29th IEEE SEMI-THERM Symposium, 65-70, 2013, and Y. Luo, “Use Isothermal Surface to Help Understanding the Spatial Representation of Structure Function”, Transactions of The Japan Institute of Electronics Packaging Vol. 5 No. 1 P63-68, 2010, which are incorporated herein by reference.

In operation 330, the calibrated parameter value computation unit 230 computes calibrated thermal model parameter values for the structure based on the plurality of simulation results and an experimental result obtained from a thermal transient response measurement of the structure. The thermal transient response measurement may be performed by a commercial thermal transient test instrument such as the thermal transient tester (T3Ster) available from Mentor Graphics Corporation of Wilsonville, Oreg. As noted above, both the plurality of simulation results and the experiment result may be represented by structure functions. It should be appreciated by a person of ordinary skill in the art that either the integral form of structure functions or the differential form of structure functions could be employed. It should also be appreciated by a person of ordinary skill in the art that representations other than the structure function like the Zth curve or even the temperature vs. time curve could be employed.

For calibration, the calibrated parameter value computation unit 230 may determine a deviation value for each of the plurality of thermal model parameter value sets by comparing each of the plurality of simulation results with the experimental result. With various implementations of the disclosed technology, the sum of squared errors may be used as an optimization cost function. A response surface of the sums of squared errors vs. thermal model parameter values is then formed. The response surface methodology may be employed to obtain a set of calibrated thermal model parameter values.

Different cost functions and/or different optimization approaches may be adopted by the calibrated parameter value computation unit 230.

### CONCLUSION

While the disclosed technology has been described with respect to specific examples including presently preferred modes of carrying out the disclosed technology, those skilled in the art will appreciate that there are numerous variations and permutations of the above described systems and techniques that fall within the spirit and scope of the disclosed technology as set forth in the appended claims. For example, while specific terminology has been employed above to refer to electronic or mechanical computer-aided engineering design processes, it should be appreciated that various examples of the disclosed technology may be implemented using any desired combination of electronic or mechanical design processes.

What is claimed is:

1. A method, executed by at least one processor of a computer, comprising:
determining a plurality of thermal model parameter value sets for a structure, each of the plurality of thermal model parameter value sets consisting of preliminary values for a set of thermal model parameters, the structure including at least one microelectronic device;
performing thermal transient response simulations using the plurality of thermal model parameter value sets to obtain a plurality of simulation results, each of the plurality of simulation results being derived based on one of the plurality of thermal model parameter value sets; and
computing calibrated thermal model parameter values for the structure based on the plurality of simulation results and an experimental result obtained from a thermal transient response measurement of the structure.

2. The method recited in claim 1, wherein the determining is based on minimum values and maximum values for the set of thermal model parameters.

3. The method recited in claim 1, wherein the set of thermal model parameters is a subset of thermal model parameters needed for the thermal transient response simulation.

4. The method recited in claim 1, wherein each of the plurality of simulation results comprises a structure function and the experimental result comprises a structure function.

5. The method recited in claim 1, wherein the computing comprises:
determining a deviation value for each of the plurality of thermal model parameter value sets.

6. The method recited in claim 5, wherein the deviation value is a sum of squared errors obtained by comparing a structure function obtained from the each of the thermal transient response simulations to a structure function obtained from the thermal transient response measurement.

7. The method recited in claim 5, wherein the computing further comprises:
constructing a response surface function using the deviation values; and
determining calibrated thermal model parameter values using response surface methodology.

8. One or more non-transitory computer-readable media storing computer-executable instructions for causing one or more processors to perform a method, the method comprising:
determining a plurality of thermal model parameter value sets for a structure, each of the plurality of thermal model parameter value sets consisting of preliminary values for a set of thermal model parameters, the structure including at least one microelectronic device;
performing thermal transient response simulations using the plurality of thermal model parameter value sets to obtain a plurality of simulation results, each of the plurality of simulation results being derived based on one of the plurality of thermal model parameter value sets; and
computing calibrated thermal model parameter values for the structure based on the plurality of simulation results and an experimental result obtained from a thermal transient response measurement of the structure.

9. The one or more non-transitory computer-readable media recited in claim 8, wherein the determining is based on minimum values and maximum values for the set of thermal model parameters.

10. The one or more non-transitory computer-readable media recited in claim 8, wherein the set of thermal model parameters is a subset of thermal model parameters needed for the thermal transient response simulation.

11. The one or more non-transitory computer-readable media recited in claim 8, wherein each of the plurality of simulation results comprises a structure function and the experimental result comprises a structure function.

12. The one or more non-transitory computer-readable media recited in claim 8, wherein the computing comprises:
determining a deviation value for each of the plurality of thermal model parameter value sets.

13. The one or more non-transitory computer-readable media recited in claim 12, wherein the deviation value is a sum of squared errors obtained by comparing a structure function obtained from the each of the thermal transient response simulations to a structure function obtained from the thermal transient response measurement.

14. The one or more non-transitory computer-readable media recited in claim 12, wherein the computing further comprises:
constructing a response surface function using the deviation values; and
determining calibrated thermal model parameter values using response surface methodology.

15. A system, comprising:
one or more processors, the one or more processors programmed to perform a method, the method comprising:
determining a plurality of thermal model parameter value sets for a structure, each of the plurality of thermal model parameter value sets consisting of preliminary values for a set of thermal model parameters, the structure including at least one microelectronic device;
performing thermal transient response simulations using the plurality of thermal model parameter value sets to obtain a plurality of simulation results, each of the plurality of simulation results being derived based on one of the plurality of thermal model parameter value sets; and
computing calibrated thermal model parameter values for the structure based on the plurality of simulation results and an experimental result obtained from a thermal transient response measurement of the structure.

16. The system recited in claim 15, wherein the determining is based on minimum values and maximum values for the set of thermal model parameters.

17. The system recited in claim 15, wherein the set of thermal model parameters is a subset of thermal model parameters needed for the thermal transient response simulation.

18. The system recited in claim 15, wherein each of the plurality of simulation results comprises a structure function and the experimental result comprises a structure function.

19. The system recited in claim 15, wherein the computing comprises:
constructing a response surface function using deviation values obtained by comparing each of the plurality of simulation results with the experimental result; and
determining calibrated thermal model parameter values using response surface methodology.

20. The system recited in claim 19, wherein each of the deviation value is a sum of squared errors obtained by comparing a structure function obtained from the each of the thermal transient response simulations to a structure function obtained from the thermal transient response measurement.
